(19) United States
(12) Patent Application Publication
(10) Pub. No.: US 2024/0384031 A1
(43) Pub. Date: Nov. 21, 2024

(54) BENZOXAZINE COMPOSITION, AND USE THEREOF

(71) Applicant: KANEKA CORPORATION, Osaka (JP)

(72) Inventors: Takefumi Furuta, Osaka (JP); Mari Yoshitake, Osaka (JP); Yoshio Furukawa, Osaka (JP)

(73) Assignee: KANEKA CORPORATION, Osaka (JP)

(21) Appl. No.: 18/689,992

(22) PCT Filed: Sep. 7, 2022
(86) PCT No.: PCT/JP2022/033501

§ 371 Date: Mar. 7, 2024

(30) Foreign Application Priority Data
Sep. 8, 2021 (JP) 2021-146403

(51) Int. Cl. C08G 65/38; C08J 5/24; C08J 11/28; C08K 7/02

(52) U.S. Cl. CPC C08G 65/38; C08J 5/246; C08J 11/28; C08K 7/02; C08J 2371/10

(57) ABSTRACT

An object of the present invention is to provide a benzoxazine composition the cured product of which has excellent self-repairability. A benzoxazine composition in accordance with an embodiment of the present invention includes: a product of reaction between a benzoxazine compound and a compound (ii) which contains at least two phenolic hydroxyl groups, and/or a mixture of the compounds (i) and (ii); and a specific crosslinking agent, so that the above problem is solved.

### TECHNICAL FIELD

The present invention relates to a benzoxazine composition and use thereof.

### BACKGROUND ART

As a raw material of electronic parts, semiconductor encapsulating materials, and the like, a phenol resin, an epoxy resin, or the like has been used. In recent years, a benzoxazine resin has been used because of, in particular, its excellent heat resistance.

For example, Patent Literature 1 discloses a resin composition which is excellent in adhesion to metal and the cured product of which is excellent in heat resistance, because of containing a phenolic resin and a disulfide compound. Patent Literature 1 also indicates that the phenolic resin can contain a benzoxazine resin.

### CITATION LIST

### Patent Literature

[Patent Literature 1]
Japanese Patent Application Publication Tokukai No. 2013-060545

### SUMMARY OF INVENTION

### Technical Problem

However, Patent Literature 1 above does not provide any disclosure or suggestion of the self-repairability of a cured product of the resin composition. An object of the present invention is to provide a benzoxazine composition the cured product of which has excellent self-repairability.

### Solution to Problem

The inventors of the present invention diligently studied the solution to the above problem. As a result, the inventors found that the cured product of a benzoxazine composition has excellent self-repairability, the benzoxazine composition including a product of reaction between a benzoxazine compound (i) and a compound (ii) which contains at least two phenolic hydroxyl groups, and/or a mixture of the compounds (i) and (ii), and a specific crosslinking agent. This led to completion of the present invention.

That is, an aspect of the present invention is a benzoxazine composition including a component (A): a product of reaction between a benzoxazine compound (i) and a compound (ii) which contains at least two phenolic hydroxyl groups, and/or a mixture of the compounds (i) and (ii); and
a component (B): a crosslinking agent containing a bond capable of bond exchange reaction and a functional group reactive with a hydroxyl group.

Further, another aspect of the present invention is a benzoxazine composition including a component (A): a product of reaction represented by the following Formula (1); and
a component (B): a crosslinking agent represented by the following Formula (2).

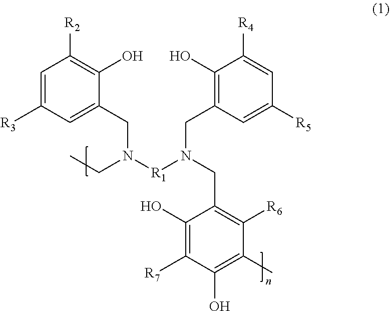

where: n is an integer; R₁ is an aromatic group and/or an aliphatic group; R₂ to R₅ each independently represent one selected from the group consisting of a halogen atom, an alkyl group, an alkyl halide group, a hydroxy group, a carboxyl group, an amino group, and an alkoxy group; and R₆ and R₇ each independently represent one selected from the group consisting of a hydrogen atom, a halogen atom, an alkyl group, an alkyl halide group, a hydroxy group, a carboxyl group, an amino group, and an alkoxy group.

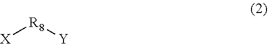

where: R₈ is an aromatic group and/or an aliphatic group, and contains a disulfide bond; and X and Y are each independently a functional group reactive with a hydroxyl group.

### Advantageous Effects of Invention

With an aspect of the present invention, it is possible to provide a benzoxazine composition the cured product of which has excellent self-repairability.

### BRIEF DESCRIPTION OF DRAWINGS

FIG. 1 is a schematic diagram illustrating an example of a mechanism of damage repair on the surface of a cured product of a benzoxazine composition in accordance with an embodiment of the present invention.

FIG. 2 illustrates observation images of scratches made on cured products in accordance with Examples of the present invention.

FIG. 3 illustrates the results of subjecting, to heat press, the cured products in accordance with Examples of the present invention.

FIG. 4 illustrates the results of dissolving, in a solvent, the cured products in accordance with Examples of the present invention, and a reaction formula expressing the solution of the cured products.

### DESCRIPTION OF EMBODIMENTS

The following description will discuss an embodiment of the present invention, but the present invention is not limited to the embodiment. As used herein, a numerical range expressed as “A to B” means “not less than A and not more than B” unless otherwise specified.

### [1. Benzoxazine Composition]

A benzoxazine composition (hereinafter, also referred to as the present benzoxazine composition) in accordance with an embodiment of the present invention includes a component (A): a product of reaction between a benzoxazine compound (i) and a compound (ii) which contains at least two phenolic hydroxyl groups, and/or a mixture of the compounds (i) and (ii); and a component (B): a crosslinking agent containing a bond capable of bond exchange reaction and a functional group reactive with a hydroxyl group.

The inventors of the present invention successfully produced a cured product having excellent self-repairability, by curing a benzoxazine composition including: a product of reaction between a benzoxazine compound (i) and a compound (ii) which contained at least two phenolic hydroxyl groups, and/or a mixture of the compounds (i) and (ii); and a specific crosslinking agent. This is a surprise because there was not such a benzoxazine composition the cured product of which also had excellent self-repairability.

As used herein, the phrase a “product of reaction between (i) and (ii)” means that before curing of a composition, (i) and (ii) are in a state of already having reacted together. Meanwhile, the phrase a “mixture of (i) and (ii)” means that before curing of a composition, (i) and (ii) are in a state of not having reacted together yet. The mixture can produce the above product of reaction as the heating for curing is carried out. Therefore, not only in a case of using the above product of reaction but also in a case of using the above mixture, the same effect can be obtained. The details of this will be described later.

As used herein, the phrase “having self-repairability” means that when a cured product having a scratch is heated, the width and/or length of the scratch become(s) smaller than before the heating.

As used herein, the phrase “having excellent self-repairability” means that when a cured product having a scratch which is not more than 10 μm in width is heated at 200° C. for one hour, the repair rate represented by the following formula is not less than 40%.

$$Repair rate ( \% ) = ( area of scratch before heating - area of scratch after heating ) / ( area of scratch before heating ) \times 100$$

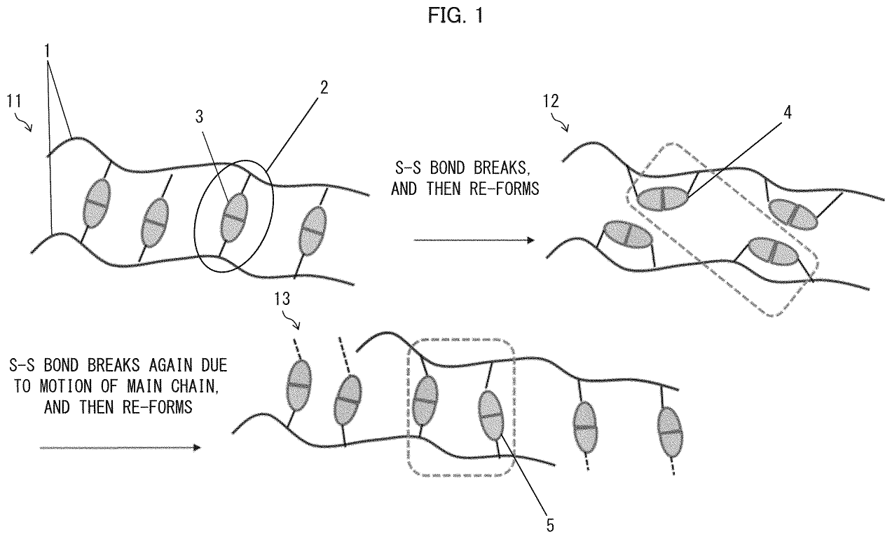

The self-repairability mechanism of the cured product of the present benzoxazine composition can be, for example, as illustrated in FIG. 1. It should be noted that the schematic diagram illustrated in FIG. 1 is an example of the reaction occurring when compounds indicated in Examples are contained as the component (A) and component (B) in the present benzoxazine composition, and the reaction mechanism of the present invention is not limited to this example. Furthermore, as the bond capable of bond exchange reaction, a disulfide bond is exemplified by way of example only, and a bond contained in the crosslinking agent is not limited to this.

The repair mechanism of the cured product will be described below in detail with use of FIG. 1. First, when the present benzoxazine composition is cured by heating, a phenolic hydroxyl group and an epoxy group contained in the cured product react together, the phenolic hydroxyl group being contained in the product of reaction between the benzoxazine compound and a compound containing at least two phenolic hydroxyl groups, the product of reaction being the component (A), the epoxy group being contained in the crosslinking agent, which is the component (B). This brings products of reaction 1, each of which is the component (A) illustrated in stage 11, into a state of being cross-linked via a crosslinking agent 2. In a case where damage is caused in a cured product in which the products of reaction, each of which is the component (A), are cross-linked via the crosslinking agent 2, the cured product is further heated. This causes a disulfide bond 3 contained in the crosslinking agent 2 to break and re-form, and a disulfide bond 4 illustrated in stage 12 is formed accordingly. Further continuing to heat the cured product causes the motion of the product of reaction 1 (main chain)-moiety, and the disulfide bond 4 breaks accordingly. Subsequently, re-formation occurs, so that a disulfide bond 5 is formed. The crosslinking agents 2 bounded by a broken line recombine via the disulfide bond 5, and the cross-linked structure illustrated in stage 13 is formed. Incidentally, in a case where a mixture of a benzoxazine compound and a compound which contains at least two phenolic hydroxyl groups is used as the component (A), the product of reaction is generated during the curing of the present benzoxazine composition by heating. This causes the same change in cross-linked structure. Therefore, a combination of the component (A) and the component (B) makes it possible to impart excellent self-repairability to the cured product.

As above, with the present benzoxazine composition, it is possible to obtain a cured product capable of self-repair, by a simple operation of heating. This makes it possible to use a cured product of the present benzoxazine composition over a long period of time.

In addition, the configuration as described above makes it possible to repair a cured product by heating and reuse the cured product, even when the cured product is damaged. This enables contribution to the achievement and implementation of Goal 12 “Ensure sustainable consumption and production patterns” of the sustainable development goals (SDGs).

A benzoxazine composition in accordance with another embodiment of the present invention includes a component (A): a product of reaction represented by the following Formula (1); and a component (B): a crosslinking agent represented by the following Formula (2).

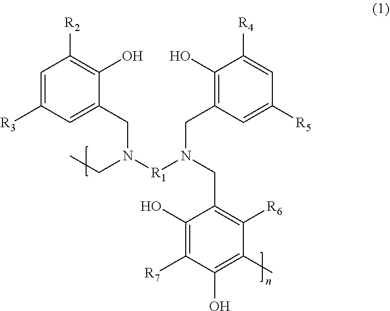

where: n is an integer; R₁ is an aromatic group and/or an aliphatic group; R₂ to R₅ are each independently one selected from the group consisting of a halogen atom, an alkyl group, an alkyl halide group, a hydroxy group, a carboxyl group, an amino group, and an alkoxy group; and R₆ and R₇ each independently represent one selected from the group consisting of a hydrogen atom, a halogen atom, an alkyl group, an alkyl halide group, a hydroxy group, a carboxyl group, an amino group, and an alkoxy group.

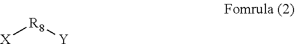

where: R₈ is an aromatic group and/or an aliphatic group, and contains a disulfide bond; and X and Y are each independently a functional group reactive with a hydroxyl group.

### <1-1. Component (A)>

The component (A) contained in the present benzoxazine composition is a product of reaction between a benzoxazine compound (i) and a compound (ii) which contains at least two phenolic hydroxyl groups, and/or a mixture of the compounds (i) and (ii). In other words, a product of reaction between the compounds (i) and (ii) may be contained in the component (A), or a mixture of the compounds (i) and (ii) may be contained in the component (A), or both the product of reaction and the mixture may be contained in the component (A).

In a case where the component (A) is a product of reaction between the compounds (i) and (ii), the compounds (i) and (ii) are allowed to react together by heat stirring or the like, before being mixed with the component (B), which will be described later. In a case where the component (A) is a mixture of the compounds (i) and (ii), the compound (i), the compound (ii), and the component (B) may be mixed simultaneously. In a case where the product of reaction and the benzoxazine compound (i) and/or the compound (ii) that have/has not reacted are present in the present benzoxazine composition, the component (A) can be said to contain a product of reaction between and a mixture of the benzoxazine compound (i) and the compound (ii).

The benzoxazine compound (i) is not particularly limited provided that the benzoxazine compound (i) is a compound containing a benzoxazine ring. Examples of the benzoxazine compound (i) include a compound represented by the following Formula (3).

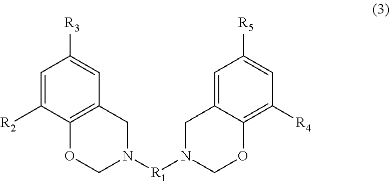

where R₁ is an aromatic group and/or an aliphatic group. R₁ may be an aliphatic group, or may be a plurality of aliphatic groups bound together by ether bond.

Examples of the aromatic group include a phenylene group, a biphenylene group, a naphthylene group, an anthranylene group, a phenanthrylene group, a pyrenylene group, a coronylene group, a terphenylene group, a furanylene group, a thienylene group, and a fluorenylene group.

In the present specification, examples of the aromatic group also include a structure in which not less than two groups of the same type or different types of the above phenylene group, biphenylene group, naphthylene group, anthranylene group, phenanthrylene group, pyrenylene group, coronylene group, terphenylene group, furanylene group, thienylene group, and fluorenylene group are connected via one bivalent linking group or two or more bivalent linking groups. In addition, examples of the aromatic group also include a non-benzene aromatic group and a heteroaromatic group.

Examples of the bivalent linking group include an alkylene group, an ether group, a carbonyl group, an amide group, an imino group, an azo group, a sulfide group, a sulfonyl group, a sulfide group, an isopropylidene group, and a hexafluorinated isopropylidene group. In addition, examples of the non-benzene aromatic group include annulene, azulene, tropone, metallocene, and any other aromatic compound having a three-membered ring structure, a five-membered ring structure, or a seven-membered ring structure.

In a case where the aromatic group has a substituent, examples of the substituent include a halogen atom, an alkyl group, a cycloalkyl group, an alkyl halide group, a hydroxy group, a carboxyl group, an amino group, an alkoxy group, a cyano group, an aryloxy group, and an aralkyloxy group.

The number of carbons of the aromatic group is preferably 6 to 200 and more preferably 6 to 50.

The aliphatic group may be either in a chain form or cyclic, and may be saturated or unsaturated. In a case where the aliphatic group is in a chain form, the aliphatic group may be linear, or may be branched. Examples of the aliphatic group in a chain form include an alkylene group, an alkenylene group, and an alkynylene group. Examples of the cyclic aliphatic group include a cycloalkylene group.

Examples of the alkylene group include a methylene group, an ethylene group, a propylene group, a butylene group, a pentylene group, and a hexylene group. Examples of the alkenylene group include a vinylene group, a 1-methylvinylene group, a propenylene group, a butenylene group, and a pentenylene group. Examples of the alkynylene group include an ethynylene group, a propynylene group, a butynylene group, a pentynylene group, and a hexynylene group. Examples of the cycloalkylene group include a cyclopropylene group, a cyclobutylene group, a cyclopentylene group, and a cyclohexylene group.

In addition, at least one hydrogen atom contained in the aliphatic group may be substituted with a halogen atom, a hydroxy group, or an alkoxy group.

The number of carbons of the aliphatic group is preferably 1 to 100, more preferably 1 to 60, and even more preferably 1 to 50. When the number of carbons falls within the above range, the cured product is excellent in self-repairability.

In Formula (3), R₂ to R₅ each independently represents one selected from the group consisting of a halogen atom, an alkyl group, an alkyl halide group, a hydroxy group, a carboxyl group, an amino group, and an alkoxy group.

The compound (ii) which contains at least two phenolic hydroxyl groups is not particularly limited provided that the compound has at least two phenolic hydroxyl groups. That is, the compound (ii) may be a diphenol, or may be a triphenol, or may be a tetraphenol.

Examples of the compound (ii) which contains at least two phenolic hydroxyl groups include a compound represented by the following Formula (4).

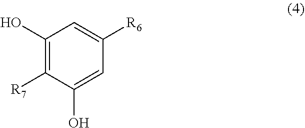

where R₆ and R₇ each independently represent one selected from the group consisting of a hydrogen atom, a halogen atom, an alkyl group, an alkyl halide group, a hydroxy group, a carboxyl group, an amino group, and an alkoxy group. Both R₆ and R₇ may be hydrogen atoms.

For example, as the compound represented by the above Formula (4), resorcinol, alkylresorcinols (such as 2-methylresorcinol, 5-methylresorcinol, 2,5-dimethylresorcinol, 2-ethylresorcinol, 2-propylresorcinol, 2-n-butylresorcinol, 2-tert-butylresorcinol, 5-n-pentylresorcinol, and 5-n-heptylresorcinol), alkoxyresorcinols (such as 2-methoxyresorcinol and 5-methoxyresorcinol), 2-aminoresorcinol, pyrogallol, and 5-methylpyrogallol can be used.

In a case where the component (A) is a product of reaction between the compounds (i) and (ii), the component (A) can be represented by the following Formula (1).

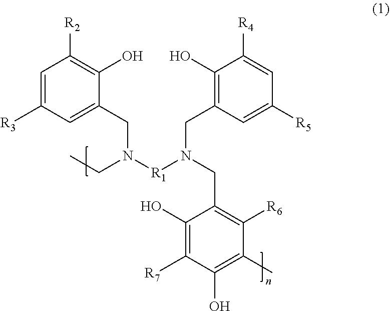

where R₁ to R₇ are as described above. In Formula (1), the hydroxyl group present in the ortho position relative to R₂ or R₄ is a hydroxyl group derived from the benzoxazine compound, and the hydroxyl group present in the ortho position relative to R₇ is a hydroxyl group derived from the compound containing at least two phenolic hydroxyl groups.

In the above Formula (1), the component (A) has a weight average molecular weight which is preferably 3000 to 20000, more preferably 4000 to 20000, and even more preferably 5000 to 20000, from the viewpoint of self-repairability. Since n of the above Formula (1) determined by GPC measurement is calculated in the form of an average value, it is difficult to accurately identify the range of n.

For example, as the component (A), a compound represented by the following Formula (5) can be used.

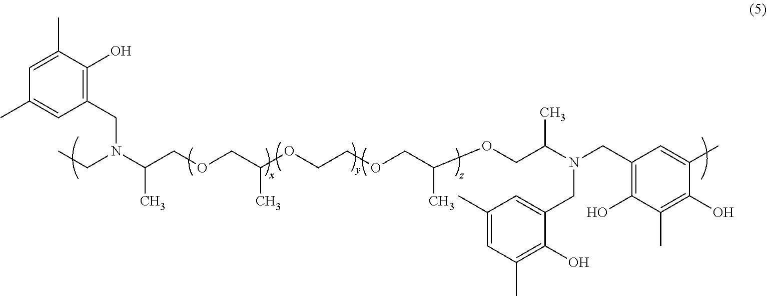

In a case where the component (A) is a product of reaction between the above compounds (i) and (ii), the amount of the component (A) contained in the present benzoxazine composition is preferably 30% by weight to 99% by weight, more preferably 35% by weight to 90% by weight, and even more preferably 40% by weight to 80% by weight. When the amount of the component (A) contained falls within the above range, the self-repairability is excellent.

In a case where the component (A) is a mixture of the compounds (i) and (ii), the amount of the compound (i) contained in the component (A) is preferably 30% by weight to 99% by weight, more preferably 50% by weight to 95% by weight, and even more preferably 80% by weight to 95% by weight. In addition, the amount of the compound (ii) contained in the component (A) is preferably 1% by weight to 70% by weight, more preferably 5% by weight to 50% by weight, and even more preferably 5% by weight to 20% by weight.

The component (A) may be chemically synthesized, or a commercially available product may be used as the component (A). In a case where the component (A) is chemically synthesized, the synthesis can be performed by, for example, the method described in Production Example 1 and Production Example 2, which will be described later. Here is a description of an example of the method for synthesizing the component (A).

For example, the benzoxazine compound (i) in the component (A) is obtained by mixing and heating components such as a diphenol component, a diamine component, and a component such as formaldehyde or paraformaldehyde, which produces formaldehyde. For example, the benzoxazine compound (i) is obtained by first heating and mixing components such as a diamine component and a component such as formaldehyde or paraformaldehyde, which produces formaldehyde, and subsequently adding a diphenol component in a molar amount which is two times the molar amount of the diamine component and allowing the components to react together at a temperature not more than 150° C. and in particular not more than 100° C.

In addition, the product of reaction between the compounds (i) and (ii) is obtained by, for example, mixing the benzoxazine compound (i) and the compound containing at least two phenolic hydroxyl groups in equimolar amounts and allowing the compounds to react together at a temperature not more than 150° C. and in particular not more than 100° C.

### <1-2. Component (B)>

The component (B) is a crosslinking agent containing a bond capable of bond exchange reaction and a functional group reactive with a hydroxyl group.

Examples of the bond exchangeable bond or structure include: a disulfide bond, an ester bond, an imine bond, a carbonate bond, a urethane bond, a urea bond, a boroxine structure, a dioxaborolane structure, a vinylogous urethane structure, a silyl ether structure, and an olefin structure. Among these, the bond exchangeable bond is preferably a disulfide bond from the comprehensive viewpoint of the difficulty of synthesis, bond stability, costs, and easiness of bond exchange (whether the breakage and the re-formation are easy due to heating, etc.), etc.

In a case where the component (B) contains a disulfide bond, the component (B) may be a compound represented by the following Formula (2).

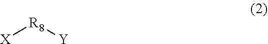

where R₈ is an aromatic group and/or an aliphatic group, and contains a disulfide bond. R₈ may be, for example, an aromatic group bound via a disulfide bond.

Examples of the aromatic group include a phenylene group, a benzylene group, a naphthylene group, and a tolylene group. In a case where the aromatic group has a substituent, examples of the substituent include a halogen atom, an alkyl group, an alkyl halide group, an alkoxy group, a cyano group, an aryloxy group. In addition, examples of the aromatic group also include a non-benzene aromatic group and a heteroaromatic group.

In Formula (2), X and Y are each independently a functional group reactive with a hydroxyl group. X and Y may be the same functional group, or may be different functional groups. Examples of the functional group reactive with a hydroxyl group include an epoxy group, a carboxyl group, an acid anhydride group, an isocyanate group, and an oxazoline group. Considering that reactivity with a phenolic hydroxyl group of the component (A) is high and a by-product is less likely to be generated, the functional group reactive with a hydroxyl group is preferably an epoxy group.

The component (B) may be, for example, a compound represented by the following Formula (6).

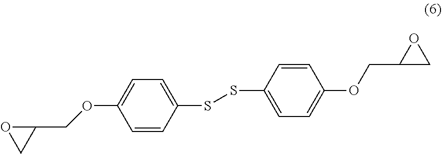 [SMILES: c1cc(SSc2ccc(OCC3CO3)cc2)ccc1OCC1CO1]

The component (B) may be chemically synthesized, or a commercially available product may be used as the component (B). In a case where the component (B) is chemically synthesized, the synthesis can be performed by, for example, the method described in Production Example 3, which will be described later.

A ratio (X)/(Y) of the equivalent (X) of the phenolic hydroxyl group contained in the component (A) to the equivalent (Y) of the functional group reactive with a hydroxyl group contained in the component (B) is preferably not less than 0.25, more preferably not less than 0.4, and even more preferably not less than 0.5. The upper limit of the ratio (X)/(Y) is not particularly limited, but may be, for example, not more than 5. The ratio (X)/(Y) can be adjusted as appropriate according to the weight ratio between the component (A) and the component (B). When the ratio (X)/(Y) falls within the above range, the self-repairability of a cured product obtained is improved.

### (Others)

The present benzoxazine composition may include a filler, a mold release, a flame retardant, a colorant, a coupling agent, and the like, where necessary. These may be mixed during production of the present benzoxazine composition, or may be mixed during curing of the present benzoxazine composition.

### [2. Cured Product]

A cured product can be obtained by curing the present benzoxazine composition. A curing method to form the cured product is not particularly limited. However, because the present benzoxazine composition has a thermosetting property, the curing of the present benzoxazine composition may be performed by heating.

The heating temperature at which the present benzoxazine composition is cured by heating is not particularly limited, provided that it is possible to sufficiently cure the present benzoxazine composition, but may be, for example, 120° C. to 240° C. The heating time is not particularly limited as well, but may be, for example, five minutes to 24 hours. The heating temperature may be constant for the duration of heating, or may be changed as appropriate where necessary. In addition, the heating may be carried out at a time, or the heating may be carried out so as to be divided into several heating stages. Also in a case where the heating is carried out in the several heating stages, the heating temperature and the heating time need not be constant.

In a case where the present benzoxazine composition is cured to form a cured product, the present benzoxazine composition may be heated while being pressurized. The pressure at which the present benzoxazine composition is pressurized is not particularly limited, but may be, for example, 0.1 MPa to 2.0 MPa. The pressurization may be carried out simultaneously with the heating, or may be carried out after the heating.

The cured product preferably contains reinforcing fibers from the viewpoint of improving the mechanical strength of the cured product. Examples of the reinforcing fibers include inorganic fibers, organic fibers, metal fibers, and reinforcing fibers of a hybrid configuration obtained by combination of the foregoing types of fibers. The reinforcing fibers can be of a single type or can be of two or more types.

Examples of the inorganic fibers include carbon fibers, graphite fibers, silicon carbide fibers, alumina fibers, tungsten carbide fibers, boron fibers, and glass fibers. Examples of the organic fibers include aramid fibers, high-density polyethylene fibers, and any other typical nylon fibers and polyester fibers. Examples of the metal fibers include fibers of stainless steel, iron, or the like. Examples of the metal fibers also include carbon coated metal fibers obtained by coating metal fibers with carbon. Among these, the reinforcing fibers are preferably carbon fibers from the viewpoint of improving the strength of the cured product.

Although typically having undergone a sizing treatment, the carbon fibers may be used without undergoing any treatment. Alternatively, where necessary, fibers obtained with use of a small amount of sizing agent may be used, or the sizing agent can be removed by an existing method such as an organic solvent treatment or a heat treatment. In addition, a fiber bundle of carbon fibers is opened with use of an air, a roller, or the like, so that a treatment which facilitates the complete spread of a resin between the individual carbon fibers may be applied.

The cured product has a glass transition temperature (Tg) which is preferably not less than −20° C., and more preferably not less than −15° C. The upper limit of the Tg is not particularly limited, but may be practically not more than 200° C. When the Tg falls within the above range, it is possible to keep a moderate balance between the self-repairability and the other physical properties (e.g., machine characteristics) of the cured product.

The cured product has a 5% weight loss temperature (Td5) which is preferably not less than 220° C., more preferably not less than 230° C., and even more preferably not less than 240° C. When the Td5 of the cured product is not less than 220° C., the cured product is not only excellent in heat resistance, but also less likely to deteriorate during the repair carried out by the method which will be described later. As used herein, a “5% weight loss temperature (Td5)” means a temperature at the time when the cured product is pyrolyzed and the weight is reduced by 5%.

The cured product has an average repair rate which is preferably not less than 40%, more preferably not less than 50%, even more preferably not less than 60%, and even more preferably not less than 65%. When the average repair rate of the cured product is not less than 40%, the cured product can be said to have excellent self-repairability. It is more preferable that the average repair rate of the cured product be higher. For example, the average repair rate may be not more than 100%, or may be not more than 90%. The phrase “excellent self-repairability” and the term “average repair rate” in the present specification are as described in the above section [1. Benzoxazine composition].

The cured product is suitably applicable to electronic materials such as electronic parts, printed wiring boards and laminated boards for a printed wiring board, semiconductor encapsulating materials, and semiconductor-mounted modules, motor vehicles or vehicles, aircraft parts, building materials, machine tools, etc. The cured product can be used in, in particular, parts of these materials that are required to have heat resistance.

### [3. Method for Repairing Cured Product]

A method for repairing a cured product in accordance with an embodiment of the present invention includes a step of heating a cured product of the present benzoxazine composition. Therefore, with the present benzoxazine composition, it is possible to repair the cured product simply by heating.

The heating temperature and heating time during the repair of the cured product can be set as appropriate according to the composition of the cured product, etc. For example, the heating temperature may be 50° C. to 300° C., may be 100° C. to 250° C., or may be 200° C. to 250° C. For example, the heating time may be five minutes to five hours, or may be 30 minutes to two hours.

### [4. Method for Reshaping Cured Product]

A method, in accordance with an embodiment of the present invention, for reshaping a cured product includes a step of heating and pressurizing the cured product of the present benzoxazine composition. The cured product of the present benzoxazine composition preferably has excellent reshapability, so that it can be reshaped in a desired shape by heating and pressurizing.

As used herein, the phrase “having reshapability” means that a cured product having undergone cure once can be reshaped in a desired shape. As used herein, the phrase “having excellent reshapability” can mean that in a case where the cured product is heated to not less than 180° C. and pressurized at not less than 1 MPa (gage pressure of a pressing machine), when the heat press deformation ratio of the cured product represented by the following formula is not less than 35, the cured product has excellent reshapability.

Heat press deformation ratio of cured product=(projected area (mm²) of cured product after heating and pressurization as viewed from directly above)/(projected area(mm²) of cured product (sphere) before heating and pressurization as viewed from directly above)

However, in a case where the spherical cured product does not spread uniformly, and the cured product after heating and pressurization has a hole, the hole portion is not included in the area of the cured product in the above formula.

The heating temperature and pressure during the reshaping of the cured product can be set as appropriate according to the composition of the cured product, etc. For example, the heating temperature may be 50° C. to 250° C., or may be 100° C. to 200° C. The pressure may be 0.01 MPa to 10 MPa, or may be 0.1 MPa to 1 MPa.

### [5. Method for Decomposing and Reusing Cured Product]

A method for decomposing a cured product in accordance with an embodiment of the present invention includes a step of heating the cured product of the present benzoxazine composition in a solvent containing a reducing agent. Since the cured product of the present benzoxazine composition preferably has excellent decomposability, it is possible to reuse the cured product, by decomposing the cured product by heating in a solvent containing a reducing agent and then recovering the cured product.

As used herein, the phrase “having decomposability” means that when heated in a solvent containing a reducing agent, the cured product completely dissolves. In a case where the cured product is heated in a solvent containing a reducing agent at 90° C. for one hour, when the weight of the cured product which remains present is not more than 0.1% of that before the heating, the cured product can be said to have excellent decomposability.

In a case where the cured product contains reinforcing fibers, the method for decomposing the cured product includes a step of heating the cured product of the present benzoxazine composition in the solvent containing a reducing agent to decompose a part of the cured product excluding the reinforcing fibers. In other words, in a case where the cured product contains reinforcing fibers, at least a part of the cured product excluding the reinforcing fibers only needs to decompose in the step of decomposing.

Examples of the solvent include N,N-dimethylformamide (DMF), N,N-dimethylacetamide, N-methyl-2-pyrrolidone, N,N-diethylacetamide, N-methylcaprolactam, γ-butyrolactone, cyclohexanone, dimethyl sulfoxide, cyclopentanone, and 1,4-dioxane.

Examples of the reducing agent contained in the solvent include (±)-dithiothreitol, 2-mercaptoethanol, 2-mercaptoethylamine hydrochloride, cysteine hydrochloride, and tris(2-carboxyethyl)phosphine hydrochloride. The concentration of the reducing agent in the solvent may be, for example, 0.1 mg/mL to 10 mg/mL.

For example, the heating temperature at which the decomposition of the cured product is carried out may be 70° C. to 120° C. The time during which the decomposition is carried out may be five minutes to five hours. During the decomposition, stirring may be carried out as appropriate.

A decomposition product, obtained by the above decomposition method, of the cured product can be recovered and reused. Specifically, by drying the decomposition solution or mixing the decomposition solution with a poor solvent, to precipitate and acquire a solid (a decomposition product of the cured product), the decomposition product of the cured product is recovered from the solvent, and by allowing the recovered decomposition product of the cured product to react in the presence of an oxidant, the decomposition product can be restored to be a cured product.

In a case where the cured product subjected to the decomposition method contains reinforcing fibers, both the decomposition product of the cured product and the reinforcing fibers can be recovered for reuse. Specifically, the decomposition product of the cured product and the reinforcing fibers are first separated from each other and recovered by filtration, centrifugation, or the like. After that, by drying the decomposition solution containing the decomposition product of the cured product or mixing the decomposition solution with a poor solvent, to precipitate and acquire a solid (a decomposition product of the cured product), the decomposition product of the cured product is recovered from the solvent, and allowing the recovered decomposition product of the cured product to react in the presence of an oxidant, the decomposition product can be restored to be a cured product containing reinforcing fibers.

### [6. Prepreg or Semipreg]

A prepreg or semipreg in accordance with an embodiment of the present invention is obtained by impregnating reinforcing fibers with the present benzoxazine composition. As used herein, a semipreg means a complex obtained by causing reinforcing fibers to be partially impregnated (be in a semi-impregnated state) with the present benzoxazine composition, so that the reinforcing fibers unite with the present benzoxazine composition.

A prepreg can be obtained from the semipreg. For example, by further heating and melting the semipreg to impregnate the reinforcing fibers with the resin, it is possible to obtain a prepreg.

As the reinforcing fibers for use in a prepreg or semipreg, the reinforcing fibers described in the above section [2. Cured product] can be used as appropriate.

The content of resin with which the reinforcing fibers are impregnated is preferably 10% by weight to 60% by weight, and more preferably 20% by weight to 50% by weight. The content of resin means the ratio of the weight of the resin to the sum of the weights of the resin and the reinforcing fibers.

With the prepreg or semipreg, it is possible to prepare a printed wiring board by, for example, heating and pressurizing the prepreg or semipreg together with metal foil to prepare a laminated board for the printed wiring board, and further forming circuitry on the laminated board. The printed wiring board thus prepared is excellent in heat resistance, machine characteristics, etc., and therefore suitably used as a semiconductor-mounted substrate or the like.

The present invention is not limited to the embodiments, but can be altered by a skilled person in the art within the scope of the claims. The present invention also encompasses, in its technical scope, any embodiment derived by combining technical means disclosed in differing embodiments.

An aspect of the present invention may include the following configurations.

<1> A benzoxazine composition including: a component (A): a product of reaction between a benzoxazine compound (i) and a compound (ii) which contains at least two phenolic hydroxyl groups, and/or a mixture of the benzoxazine compound (i) and the compound (ii); and
a component (B): a crosslinking agent containing a bond capable of bond exchange reaction and a functional group reactive with a hydroxyl group.
   <2> The benzoxazine composition described in <1>, in which the bond capable of bond exchange reaction is a disulfide bond.
   <3> A benzoxazine composition including: a component (A): a product of reaction represented by the following Formula (1); and
a component (B): a crosslinking agent represented by the following Formula (2).

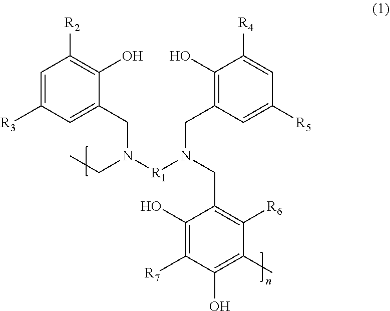

where: n is an integer; R₁ is an aromatic group and/or an aliphatic group; R₂ to R₅ each independently represent one selected from the group consisting of a halogen atom, an alkyl group, an alkyl halide group, a hydroxy group, a carboxyl group, an amino group, and an alkoxy group; and R₆ and R₇ each independently represent one selected from the group consisting of a hydrogen atom, a halogen atom, an alkyl group, an alkyl halide group, a hydroxy group, a carboxyl group, an amino group, and an alkoxy group.

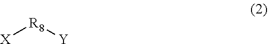

where: R₈ is an aromatic group and/or an aliphatic group, and contains a disulfide bond; and X and Y are each independently a functional group reactive with a hydroxyl group.
   <4> The benzoxazine composition described in any one of <1> to <3>, in which the functional group reactive with a hydroxyl group is an epoxy group.
   <5> The benzoxazine composition described in any one of <1> to <4>, in which the benzoxazine composition has a ratio (X)/(Y) of not less than 0.25, the ratio (X)/(Y) being a ratio of an equivalent (X) of the phenolic hydroxyl groups contained in the component (A) to an equivalent (Y) of the functional group reactive with a hydroxyl group, contained in the component (B).
   <6> A cured product obtained by curing the benzoxazine composition described in any one of <1> to <5>.
   <7> The cured product described in <6>, further including reinforcing fibers.
   <8> A method for repairing a cured product, the method including a step of heating the cured product described in <6> or <7>. <9> A cured product reshaping method including a step of heating and pressurizing the cured product described in <6> or <7>.
   <10> A cured product decomposition method including a step of heating the cured product described in <6> or <7> in a solvent containing a reducing agent.
   <11> A cured product decomposition method including a step of heating the cured product described in <7> in a solvent containing a reducing agent to decompose a part of the cured product excluding the reinforcing fibers.
   <12> A cured product reuse method including a step of recovering a decomposition product of a cured product obtained by the cured product decomposition method described in <10> to reuse the decomposition product.
   <13> A cured product reuse method including a step of recovering reinforcing fibers and a decomposition product of the cured product obtained by the cured product decomposition method described in <11> to reuse the reinforcing fibers and the decomposition product.
   <14> A prepreg or semipreg obtained by impregnating reinforcing fibers with the benzoxazine composition described in any one of <1> to <5>.

### EXAMPLES

An embodiment of the present invention will be described below in more detail through Examples and Comparative Example. The present invention is not limited to the following Examples.

### [Test Method]

### (Structure Analysis of Benzoxazine Compound and Crosslinking Agent)

A molecular structure analysis of the benzoxazine compound and the crosslinking agent was carried out with use of a nuclear magnetic resonator (NMR, AVANCEIII 400 MHz manufactured by Bruker Corporation), through ¹H-NMR measurement carried out under conditions where the number of scans was 16 and a measurement temperature was room temperature.

### (Measurement of Molecular Weights of Benzoxazine Compound and Product of Reaction Between Benzoxazine Compound and 2-Methylresorcinol)

The molecular weights of the benzoxazine compound and the product of reaction between the benzoxazine compound and 2-methylresorcinol were evaluated with use of a gel permeation chromatograph (GPC) (Prominence UFLC manufactured by Shimadzu Corporation) under the following conditions: the eluent was 0.01 mol/L lithium chloride-containing DMF; three columns of TSKgel GMHHR-M were linked together in series; the flow rate was 1 mL/min; the injection volume was 20 μL; the column temperature was 40° C.; a UV detector; the sample of a calibration curve was polystyrene.

### (Glass Transition Temperature (Tg) of Cured Product)

The DSC curve of the cured product was measured with use of a differential scanning calorimeter (DSC, DSC7000X manufactured by Hitachi High-Tech Science Corporation), with a nitrogen flow rate of 40 mL/min, under a condition of 10° C./min. The extrapolated glass transition onset temperature (the intersection of a line obtained by extending to a higher temperature region by extrapolation, the baseline before the inflection point of an obtained DSC curve and the tangent line at the inflection point) determined from the DSC curve was used as the glass transition temperature in the present specification.

### (Thermal Stability of Cured Product)

The 5% weight loss temperature (Td5) of the cured product was evaluated with use of a thermogravimetric analyzer (STA7200 manufactured by Hitachi High-Tech Science Corporation) in a nitrogen gas stream of 200 mL/min at a temperature increase rate of 5° C./min.

### (Evaluation of Repairability of Cured Product)

After a cut of not more than 10 μm in width was made on the surface of the cured product with a cutter, the cured product was heated in the air at 200° C. for one hour. The cut was observed before and after the heating with a digital microscope (VHX-200 manufactured by Keyence Corporation). From the change in the cut, the repair rate was calculated from the following formula, and repairability was evaluated accordingly.

$$Repair rate ( \% ) = ( area of scratch before heating - area of scratch after heating ) / ( area of scratch before heating ) \times 100$$

### (Evaluation of Reshapability of Cured Product)

A spherical cured product (the weight of which is approximately 10 mg) 3 mm to 4 mm in diameter was produced, and was subjected to heat press with use of a heat pressing machine (Mini Test Press 10 manufactured by Toyo Seiki Seisaku-sho Ltd.) under conditions of 180° C., 15 minutes, and 1 MPa (gage pressure), to calculate the degree of spread, which is the deformation ratio, of the cured product from the following formula, and evaluate the reshapability accordingly.

Heat press deformation ratio of cured product=(projected area (mm²) of cured product after heating and pressurization as viewed from directly above)/(projected area(mm²) of cured product (sphere) before heating and pressurization as viewed from directly above)

However, in a case where the spherical cured product does not spread uniformly, and the cured product after heating and pressurization has a hole, the hole portion is not included in the area of the cured product in the above formula.

### (Evaluation of Decomposability of Cured Product)

In each of DMF (5 mL) and DMF (5 mL) in which (±)-dithiothreitol (2 mg) was dissolved, 10 mg of the cured product was immersed and heated and stirred at 90° C. for one hour. The degree of solution of the cured product was judged visually, and the decomposability was evaluated.

### Production Example 1

Jeffamine ED-900 (10.0357 g, 0.0112 mol) and paraformaldehyde (1.5644 g, 0.0489 mol) were put in a reaction vessel equipped with a stirrer, and was stirred at 100° C. for 30 minutes. Subsequently, 2,4-dimethylphenol (2.7191 g, 0.0225 mol) was added to the reaction solution, and the reaction solution was then stirred at 100° C. for 14 hours. After the reaction solution was cooled to room temperature, 60 mL of chloroform was added to the reaction solution, and liquid separations were carried out three times with use of 100 mL of a 0.1 mol/L aqueous solution of sodium hydroxide and three times with use of 100 mL of pure water After an organic layer solution was mixed with 100 mL of hexane, and a supernatant liquid was recovered, a solvent was removed at 30° C. under reduced pressure with use of an evaporator. A benzoxazine compound, which was a target substance, was thereby obtained. From a GPC measurement, the weight average molecular weight (Mw) of the obtained target substance was found to be 4600. By carrying out the ¹H-NMR measurement (the deuterated solvent is DMSO-d₆), the disappearance of a peak of 2,4-dimethylphenol (raw material) at 6.8 ppm and the formation of peaks of the benzoxazine compound (product) at 3.9 ppm and 4.9 ppm were observed. It was thus confirmed that a target substance was successfully synthesized.

### Production Example 2

The benzoxazine compound (5.0027 g, 0.0042 mol) obtained in Production Example 1 and 2-methylresorcinol (0.5207 g, 0.0042 mol) were put in a reaction vessel, and were stirred at 100° C. for three hours. A product of reaction between the benzoxazine compound and 2-methylresorcinol was thus obtained. From a GPC measurement, the weight average molecular weight of the target substance obtained was found to be 6900, and it was thus confirmed that the compound of Formula (5) was obtained.

### Production Example 3

In a 100-mL four-necked eggplant flask equipped with a stirrer, bis(4-hydroxyphenyl) disulfide (2.0000 g, 0.0080 mol), potassium carbonate (11.0438 g, 0.0799 mol), and N,N-dimethylformamide (37.77 g) were put. Subsequently, the temperature was increased to 60° C. while stirring was carried out in a nitrogen gas stream, and then epibromohydrin (10.9000 g, 0.0796 mol) was gradually added dropwise through a drop funnel. Subsequently, the epibromohydrin remaining in the drop funnel was washed with N,N-dimethylformamide (5.0000 g) and added to the reaction solution. After allowed to react at 60° C. for 4.5 hours, the reaction solution was cooled to room temperature, and potassium carbonate was recovered by suction filtration and washed with N,N-dimethylformamide (48.00 g). Next, pure water (50.00 g) was added to the filtrate, and an extraction operation was carried out three times with use of a mixed solvent of chloroform and hexane (the volume ratio of chloroform to hexane was 4:6). A target substance was thus extracted into the organic layer. The organic layer was washed three times with pure water and once with saturated saline, and then dehydrated with use of sodium sulfate, and the solvent was removed under reduced pressure with use of an evaporator. Subsequently, recrystallization from methanol was carried out, and a solid obtained by the recrystallization was recovered by filtration, and then dried in a vacuum at 60° C., and bis(4-glycidyloxyphenyl) disulfide (a crosslinking agent containing a disulfide bond), which is a target substance, was thus obtained. From the ¹H-NMR measurement (the deuterated solvent was deuterated chloroform), the following peaks were observed: peaks of protons of a benzene ring proton derived from bis(4-hydroxyphenyl) disulfide, which is a raw material, at 7.39 ppm and 6.85 ppm; peaks of protons of a methylene group adjacent to an ether bond at 4.23 ppm and 3.93 ppm; a peak of protons of tertiary carbon atoms of an epoxy group at 3.37-3.34 ppm; and peaks of protons of secondary carbon atoms of an epoxy group at 2.92 ppm and 2.76 ppm. It was thus confirmed that the compound of Formula (6), which is a target substance, was synthesized.

### (Raw Material Compound)

The following are the raw materials used in the following Examples and Comparative Example.

<Component (A): A Product of Reaction Between or a Mixture of a Benzoxazine Compound and a Compound containing at least two phenolic hydroxyl groups>
a mixture of 2-methylresorcinol and a compound synthesized in Production Example 2 and represented by Formula (5) or a benzoxazine compound synthesized in Production Example 1
   <Component (B): A Crosslinking Agent Containing a Bond Capable of Bond Exchange Reaction and a Functional Group Reactive with a Hydroxyl Group>
a compound synthesized in Production Example 3 and represented by Formula (6)

### <Component (C): Another Crosslinking Agent>

a bisphenol A epoxy resin (JER828EL manufactured by Mitsubishi Chemical Co., Ltd.)

### Example 1

The component (A), which was a mixture of the benzoxazine compound (0.2000 g) obtained in Production Example 1 and 2-methylresorcinol (0.0219 g), which is a compound containing at least two phenolic hydroxyl groups, and the component (B), which was the crosslinking agent (0.0611 g) obtained in Production Example 3 and containing a disulfide bond, as the component (B), were mixed and heated at 80° C. for one hour, so that the uniform liquid composition was prepared. By pouring the composition onto a Teflon (registered trademark) film and heating the composition via a heat pressing machine (Mini Test Press 10 manufactured by Toyo Seiki Seisaku-sho Ltd.) under a pressure of 1.4 MPa at 160° C. for two hours and at 200° C. for two hours. A cured product was thus obtained. The amount of the component (B) was such that the equivalent ratio of the epoxy group to the phenolic hydroxyl group contained in the component (A) stood at 0.5:1.

### Example 2

A cured product was obtained by a method similar to that used in Example 1, except that: the product of reaction (0.2000 g) obtained in Production Example 2 was used as the component (A); the crosslinking agent obtained in Production Example 3 and containing a disulfide bond was used as the component (B) in an amount of 0.0551 g; and the pressure was 0.3 MPa. The amount of the component (B) was such that the equivalent ratio of the epoxy group to the phenolic hydroxyl group contained in the component (A) stood at 0.5:1.

### Comparative Example 1

A cured product was obtained by a method similar to that used in Example 1, except that: the component (B) was not used; a bisphenol A epoxy resin (0.0637 g) was used as the component (C); the pressure was 1.8 MPa; and heating conditions were 160° C. for two hours, 200° C. for two hours, and 210° C. for 0.5 hours. The component (C) does not have a bond capable of bond exchange reaction. The amount of the component (C) was such that the equivalent ratio of the epoxy group to the phenolic hydroxyl group contained in the component (A) stood at 0.5:1.

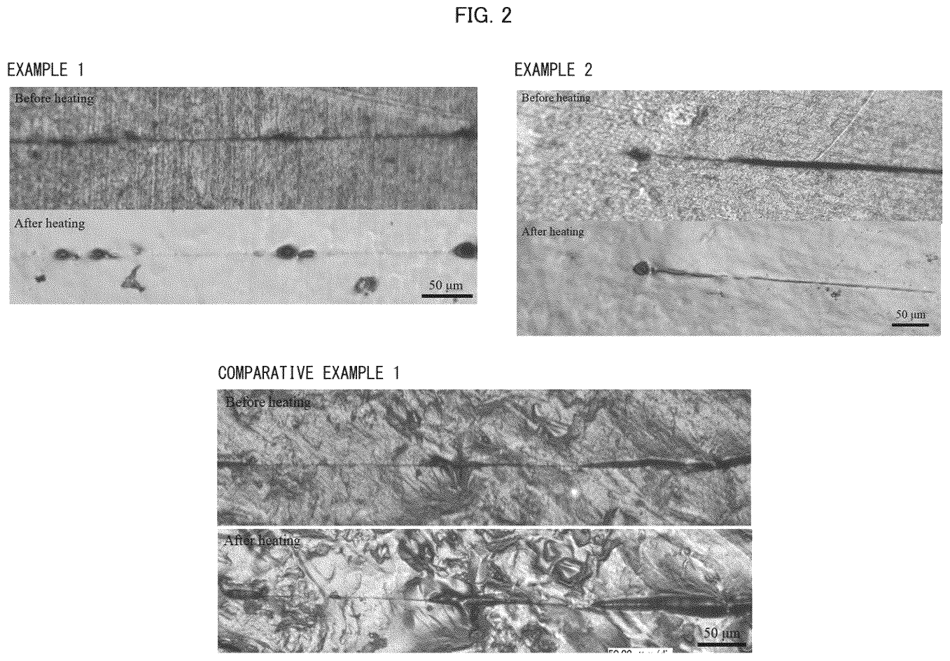

The results obtained for Examples 1 and 2 and Comparative Example 1 are presented in Table 1 and FIGS. 2 to 4.

TABLE 1

| | | | | Comparative |
|---|---|---|---|---|
| | Material | Example 1 | Example 2 | Example 1 |
| Components | Component (A) (weight ratio) | 78.4 | 78.4 | 77.7 |
| of | Component (B) (weight ratio) | 21.6 | 21.6 | — |
| composition | Component (C) (weight ratio) | — | — | 22.3 |
| | Type of component (A) | Mixture | Product of | Mixture |
| | | | reaction | |
| | Ratio (X)/(Y) of equivalent (X) of phenolic | 1/0.5 = 2 | 1/0.5 = 2 | 1/0.5 = 2 |
| | hydroxyl group derived from component (A) to | | | |
| | equivalent (Y) of epoxy group derived from | | | |
| | component (B) or component (C) | | | |
| | | | | Comparative |
| | Item | Example 1 | Example 2 | Example 1 |
| Physical | Glass transition temperature (Tg) (° C.) | −16 | −18 | −26 |
| properties | 5% Weight loss temperature (Td5) (° C.) | 248 | 252 | 262 |
| of cured | Repair rate (° C.) | 93 | 69 | 39 |
| product | Heat press deformation ratio of cured product | 38 | 57 | 31 |
| | Decomposability | Decomposed and | Decomposed and | Partially dissolved |
| | | completely | completely | (only part of cured |
| | | dissolved | dissolved | product decomposed) |

### CONCLUSION

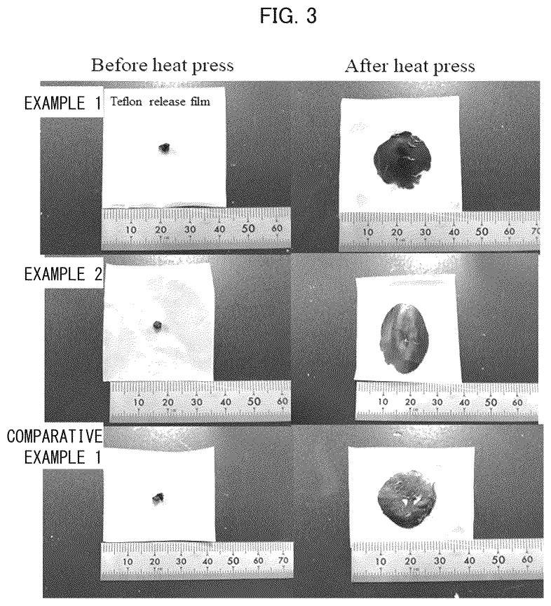

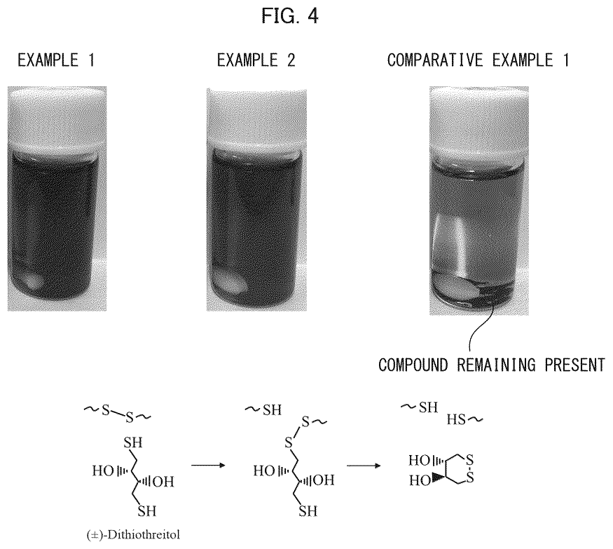

As can be seen from Table 1 and FIG. 2, Example 1 and Example 2, in which the crosslinking agent obtained in Production Example 3 and containing a disulfide bond was used as the component (B), have higher cut repair rates than Comparative Example 1, in which a bisphenol A epoxy resin was used as the crosslinking agent instead of a crosslinking agent containing a disulfide bond. In addition, it is understood from Table 1 and FIG. 3 that Example 1 and Example 2 have higher heat press deformation ratios (reshapability) of the cured products than Comparative Example 1. Further, it is understood from Table 1 and FIG. 4 that Example 1 and Example 2 are higher in cured product decomposability than Comparative Example 1. Specifically, FIG. 4 shows the following: when (±)-dithiothreitol was added, in each of Example 1 and Example 2, the presence of the cured product could not be visually recognized and the color of the solution changed; therefore, almost the entire cured product is found to decompose, whereas in Comparative Example, the cured product remained present and a change in the color of the solution was small; therefore, only a part of the cured product is found to decompose. It should be noted that the reaction formula illustrated in FIG. 4 is the formula of reaction occurring when a disulfide bond in the cured product reacts with (±)-dithiothreitol and is thereby cleaved and converted to a thiol group, and as a result, the cured product decomposes and dissolves in a solvent.

As can be seen from the above, according to the present invention, the cured product of a composition which includes a combination of the component (A) and the component (B) exhibits excellent self-repairability, reshapability, and decomposability.

### INDUSTRIAL APPLICABILITY

The present invention is suitably applicable to electronic materials such as electronic parts, printed wiring boards and laminated boards for a printed wiring board, semiconductor encapsulating materials, and semiconductor-mounted modules, motor vehicles or vehicles, aircraft parts, building materials, machine tools, etc.

### REFERENCE SIGNS LIST

1: Product of reaction
2: Crosslinking agent
3, 4, 5: Disulfide bond

1. A benzoxazine composition comprising:
a component (A): a product of reaction between a benzoxazine compound (i) and a compound (ii) which contains at least two phenolic hydroxyl groups, and/or a mixture of the benzoxazine compound (i) and the compound (ii); and
a component (B): a crosslinking agent containing a bond capable of bond exchange reaction and a functional group reactive with a hydroxyl group.

2. The benzoxazine composition according to claim 1, wherein the bond capable of bond exchange reaction is a disulfide bond.

3. A benzoxazine composition comprising:
a component (A): a product of reaction represented by the following Formula (1); and
a component (B): a crosslinking agent represented by the following Formula (2), 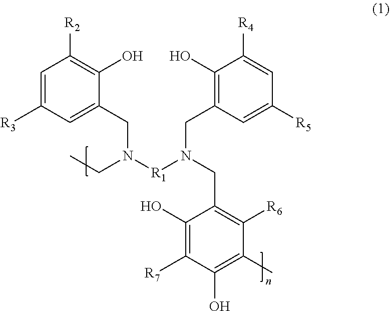
where: n is an integer; R₁ is an aromatic group and/or an aliphatic group; R₂ to R₅ each independently represent one selected from the group consisting of a halogen atom, an alkyl group, an alkyl halide group, a hydroxy group, a carboxyl group, an amino group, and an alkoxy group; and R₆ and R₇ each independently represent one selected from the group consisting of a hydrogen atom, a halogen atom, an alkyl group, an alkyl halide group, a hydroxy group, a carboxyl group, an amino group, and an alkoxy group, 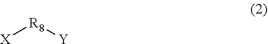
where: R₈ is an aromatic group and/or an aliphatic group, and contains a disulfide bond capable of bond exchange reaction; and X and Y are each independently a functional group reactive with a hydroxyl group.

4. The benzoxazine composition according to claim 1, wherein the functional group reactive with a hydroxyl group is an epoxy group.

5. The benzoxazine composition according to claim 1, wherein the benzoxazine composition has a ratio (X)/(Y) of not less than 0.25, the ratio (X)/(Y) being a ratio of an equivalent (X) of the phenolic hydroxyl groups contained in the component (A) to an equivalent (Y) of the functional group reactive with a hydroxyl group, contained in the component (B).

6. A cured product obtained by curing the benzoxazine composition according to claim 1.

7. The cured product according to claim 6, further comprising reinforcing fibers.

8. A method for repairing a cured product, the method comprising a step of heating the cured product according to claim 6.

9. A cured product reshaping method comprising a step of heating and pressurizing the cured product according to claim 6.

10. A cured product decomposition method comprising a step of heating the cured product according to claim 6 in a solvent containing a reducing agent.

11. A cured product decomposition method comprising a step of heating the cured product according to claim 7 in a solvent containing a reducing agent to decompose a part of the cured product excluding the reinforcing fibers.

12. A cured product reuse method comprising a step of recovering a decomposition product of a cured product obtained by the cured product decomposition method according to claim 10 to reuse the decomposition product.

13. A cured product reuse method comprising a step of recovering reinforcing fibers and a decomposition product of the cured product obtained by the cured product decomposition method according to claim 11 to reuse the reinforcing fibers and the decomposition product.

14. A prepreg or semipreg obtained by impregnating reinforcing fibers with the benzoxazine composition according to claim 1.
